(19) United States
(12) Patent Application Publication
(10) Pub. No.: US 2012/0293547 A1
(43) Pub. Date: Nov. 22, 2012

(54) Management Of Access To And Life Cycles Of Virtual Signs

(75) Inventors: Kun Bai, Elmsford, NY (US); David F. Bantz, Portland, ME (US); Steven J. Mastrianni, Unionville, CT (US); James R. Moulic, Poughkeepsie, NY (US); Dennis Shea, Ridgefield, CT (US)

(73) Assignee: International Business Machines Corporation, Armonk, NY (US)

(21) Appl. No.: 13/112,158

(22) Filed: May 20, 2011

(51) Int. Cl. G09G 5/00

(52) U.S. Cl. 345/633

(57) ABSTRACT

Many different methods, apparatus, and program products are disclosed for handling virtual signs over their life cycles. Potential future locations and headings of a mobile device are used to fetch virtual signs in advance of when the virtual signs might be used. Techniques are disclosed for handling timelines of virtual signs, including registering and responding to events in the timelines. Techniques are disclosed for allowing localities to license virtual signs. Techniques are disclosed to allow advertisers to bid for and win virtual sign competitions and product placement. Techniques are presented for presenting billing information to owners of virtual signs.

### BACKGROUND

This invention relates generally to management of virtual objects, and, more specifically, relates to the management of access to and the life cycle of virtual signs.

A “virtual sign” is, in one version, a combination of computer data and software whose behavior is such that when a computer user with a mobile computing device approaches a geographic region from a given direction, some visual or other notice is provided to the user of the given virtual sign. For example, a visual representation of a virtual sign for a restaurant might be shown to a mobile computer user when that user is within a block of the restaurant and facing in the direction of the restaurant, as in the mobile application Yelp from acrossair.com. Virtual signs are a class of applications known as “augmented reality” in which natural imagery and artificial images are combined in the viewer's field of view.

However useful, virtual signs diminish in usefulness if there are too many of them, if they are not relevant to the user's interests, if their content is inaccurate, or if the signs are obsolete.

### SUMMARY

Apparatus, methods, and program products are disclosed that perform the following: determining a potential future location and a potential future heading of the apparatus; requesting from a server a virtual sign that corresponds to the potential future location and potential future heading; receiving from the server the virtual sign that corresponds to the potential future location and potential future heading and placing the virtual sign into a selected one of the one or more memories; in response to a current location meeting the future location and a current heading meeting the future heading, presenting a representation of the virtual sign to the user; and in response to the future location and future heading being determined as improbable, removing the virtual sign from the selected memory.

Apparatus, methods, and program products are disclosed that perform the following: accessing a timeline for a virtual sign; determining an event from the timeline to be registered based on time and date information for the event being sooner in time and date than time and date information for any other events in the timeline; registering the event; determining that the registered event occurs in response to a current time and date meeting the time and date information for the registered event; in response to the determining the registered event occurs, applying one or more changes to the virtual sign based on the event.

Apparatus, methods, and program products are disclosed that perform the following: for a selected virtual sign used to respond to requests received from mobile devices for virtual signs by transmitting the virtual sign to the mobile devices making the requests, determining charging information to be used by a charging authority to charge an owner of the virtual sign; and sending the charging information to the owner of the virtual sign.

### BRIEF DESCRIPTION OF THE SEVERAL VIEWS OF THE DRAWINGS

FIG. 1 illustrates an exemplary overall configuration of a mobile communication system in which the invention may be practiced;

FIG. 2 illustrates exemplary hardware and software components of a mobile device of the system and its relationship to servers;

FIG. 3 is a flowchart of an exemplary method performed by a mobile device for access to and presentation of virtual signs;

FIG. 4 illustrates an exemplary messaging diagram between a mobile device and a virtual sign server;

FIG. 5 illustrates exemplary hardware and software components of servers of the system and connection to a network through other devices;

FIG. 6 is a flowchart of an exemplary method performed by a virtual sign server for providing access to virtual signs;

FIGS. 7 and 8 illustrate exemplary messaging diagrams between a mobile device and a virtual sign server and further illustrate possible actions taken in FIGS. 3 and 6;

FIG. 9 illustrates a portion of a device suitable for the mobile device or virtual sign server

FIG. 10 illustrates movement of a user through two different positions and the representations of different virtual signs for the different positions;

FIG. 11 is a flowchart of an exemplary method performed by a virtual sign server for providing access to virtual signs;

FIG. 12 is a flowchart of an exemplary method performed by a virtual sign server for activating a virtual sign;

FIG. 13 is a flowchart of an exemplary method performed by a virtual sign server for changing a virtual sign;

FIG. 14 is an example of a timeline and its associated states;

FIG. 15 shows examples of two virtual signs corresponding to FIG. 14;

FIG. 16 is a flowchart of an exemplary method performed by a sign server to allow a locality to license virtual signs to be presented within the boundaries of the locality;

FIG. 17 is a flowchart of an exemplary method performed by a sign server to allow a charging utility to bill a sign owner;

FIG. 18 is a flowchart of an exemplary method performed by a sign server to collect and send information about presentation of a visual sign to a charging authority;

FIG. 19 is a flowchart of an exemplary method performed by a mobile device to collect and send information about presentation of a visual sign to a sign server; and

FIG. 20 is an example of additional information to be stored in a virtual sign.

### DETAILED DESCRIPTION

As described above, virtual signs may diminish in usefulness under certain conditions. Exemplary embodiments of the invention, then, are directed to mobile computing augmented reality, specifically virtual signs, and provide a system for the control of access to such signs, managing such signs through their lifetime, and charging fees for posting such signs.

Before proceeding with additional detail regarding the instant invention, it is helpful to describe further an exemplary type of environment in which the exemplary embodiments of the invention might take place. “Augmented reality” and “virtual signage” are relatively recent additions to computing lexicon, but there have been advances in these areas. The software and hardware technologies of determining the location of a mobile device (e.g., a mobile computer) and the direction of view of its camera are well-known, as is the positioning and superimposition of arbitrary images on real-time video imagery taken by the camera of a mobile device. To date, however, virtual signs are generally permanent, unchanging and free. This will eventually lead to unwelcome clutter posing at least an annoyance to the user. This is also the case for real signs, with many examples of signs for temporary events persisting long after their period of relevance, and unauthorized signs being posted, contributing to visual clutter.

An exemplary aspect of the invention is to automatically manage virtual signs, specifically to automatically control access to such signs, to change their appearance over time (one exemplary aspect of aging), to make sure that their content remains relevant, to take them down when they are no longer needed and to arrange for control of and charging for such signs by authorized agencies.

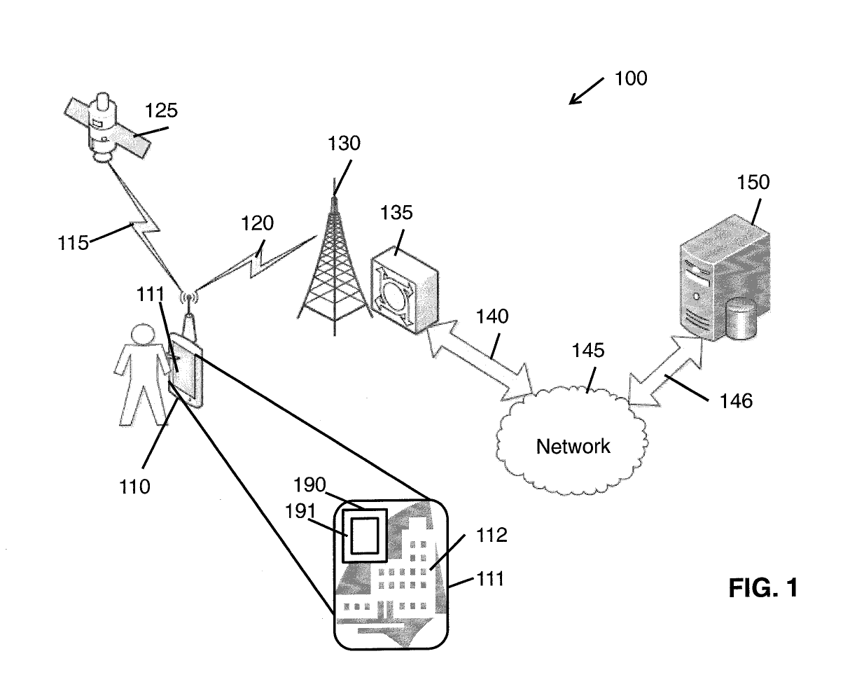

Exemplary embodiments of the instant invention will now be described. FIG. 1 shows an exemplary overall configuration of a mobile communication system 100 in which the invention may be practiced. In the figure, a user is interacting with a mobile device (e.g., smartphone) 110 that supports two radio links 115, 120, one (115) from a GPS satellite 125 and the other a radio link 120 to a cell tower 130 with an associated communications processor 135. The communications processor 135 attaches to a network 145 (e.g., the Internet) via a link 140 and through that network 145 communicates with a server 150 via a link 146. The server 150 contains data pertaining to the display of virtual signs.

In operation, the smartphone 110 determines its location with the assistance of GPS signals from the satellite 125. Not shown is an electronic compass which may be implemented separately. This compass can be used to determine the orientation of the smartphone 110 in space. Also not shown is the smartphone camera which may be used to continuously image the surroundings of the smartphone 110 on the smartphone screen 111, which can also display virtual signs.

In an exemplary embodiment, the screen 111 of the mobile device 110 is showing a picture 112 taken by a camera of the mobile device 110. Overlaid on the picture 112 is a visual representation 190 of a virtual sign that corresponds to the picture 112 (e.g., the representation 190 of the virtual sign has data corresponding to the picture 112 based at least on orientation and location). Reference 191 is described below.

Although a cell tower 130 is shown in FIG. 1, a Wi-Fi hotspot could be used instead. Wi-Fi is a local wireless networking technology.

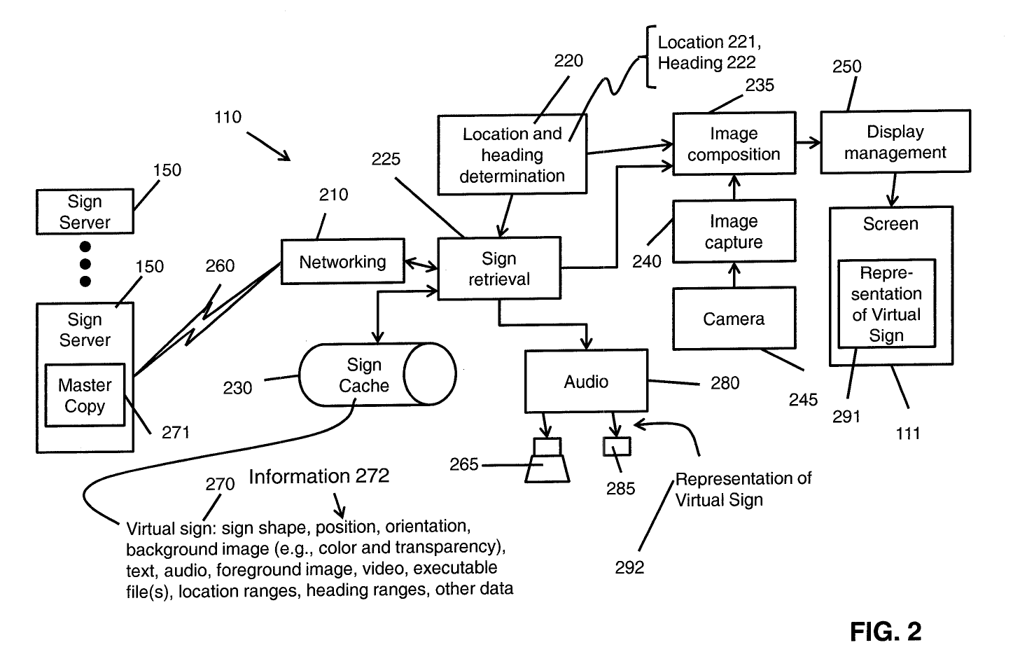

FIG. 2 illustrates exemplary hardware and software components of a mobile device 110 relevant to the display and management of virtual signs. This figure also shows a relationship with sign servers 150. In the figure, there are three input systems: networking circuitry 210, location and heading determination circuitry 220, and the image capture circuitry 240. Networking circuitry 210 retrieves information corresponding to virtual signs from one or more sign servers 150 via a link 260 (e.g., a radio link 120 of FIG. 1). Not shown for simplicity in FIG. 2 are the intermediaries (see FIG. 1) that come between the networking circuitry 210 and the sign server 150. Location and heading determination circuitry 220 determines, by whatever techniques are available, the location 221 (and, e.g., altitude, if available) and heading 222 of the mobile device 110. The location 221 is a geographic location and may be defined, for instance, by GPS data. The heading 222 may be, e.g., a direction (e.g., northwest) or a more complex orientation described by a three-dimensional value. The camera 245 images the surroundings of the mobile device 110 and supplies images or video through the image capture circuitry 240 for subsequent display on the screen 111.

Sign retrieval 225 is typically a software element that makes use of the current location 221 and heading 222 of the mobile device 110 to request and subsequently receive selected virtual signs via networking circuitry 210. Sign retrieval 225 also manages and may make use of a sign cache 230, which includes local storage of multiple virtual signs that may or may not be relevant to the needs of the current visual representation 291 on the screen 111 of the virtual sign 270. Image composition 235 is typically a software element that takes video from image capture circuitry 240 and information from relevant virtual signs 270 and creates (a sequence of) images for screen 111. The display management circuitry 250 displays the images on the screen 111. Note that image composition 235 also may need knowledge of location 221 and heading 222 to properly render the virtual signs 270 from the viewpoint of the mobile device 110. The sign cache 230 contains each virtual sign 270. The audio circuitry 280 is used to present an audio representation 292 of the virtual sign 270 on, e.g., a speaker 265 or an audio output (e.g., audio jack) 285. In one example, the sign retrieval 225 extracts audio from the virtual sign 270 and sends the audio to audio circuitry 280.

In the example of FIG. 2 and as used herein, a virtual sign 270 is defined by certain information 272. This information 272 includes one or more of sign shape, position of the representation, orientation (the normal to the sign face) of the representation, background image (e.g., color and transparency) of the representation, text to appear on the representation, audio to be played for the representation, foreground image of the representation, video to be played for the representation, location ranges in which the virtual sign is valid, heading ranges in which the virtual sign is valid, executable file(s), and other data. This information 272 is used to present a representation of the virtual sign to a user. It should be noted that, unlike “real”, physical signs, virtual signs can also be equally visible from any direction. The representation may be a visual representation 291 and displayed on screen 111. The representation may be an audio representation 292 and played via speaker 265 and/or audio output 285. The representation may be both representations 291 and 292. The executable files may be used to present the representations 291, 292 corresponding to the virtual sign 270 as an adjunct to image composition 235 and sign retrieval 225, respectively.

There are two implications of this figure for the management of virtual signs 270. The first concerns the sign cache 230. Previously-retrieved virtual signs 270 are stored in the sign cache to improve responsiveness and to give a measure of operability under difficult or nonexistent networking conditions. But the copy of the virtual sign 270 on the server 150 is the master copy 271, and changes made to that copy must be reflected in subsequent display. Thus when a network is present, the sign retrieval 225 should interrogate the server 150 to determine if the locally-cached copy 270 is the same as the server copy 271, and should download a new copy from the server if the local copy is not. It should be noted that not all information needs to be downloaded. For instance, if the only difference between the two copies 270, 271 is a foreground image, only the new foreground image need be downloaded.

If there is no network available, the cached copy 270 can be used, with the caveat that this copy 271 may not reflect the current state of the sign as stored on the server. This can be signaled to the user by, e.g., rendering the sign in some distinctive way, say as a specific color, or as partially transparent. In the example of FIG. 1, an outline 191 is provided around the edges of the representation 190, and this outline (e.g., in red) indicates the virtual sign might not be up to date. In this manner, sign management performed on the server copy 271 of the sign is always either accurately reflected by the mobile device 110 or an indication is given to the user that the displayed sign is potentially obsolete. If the representation includes only an audio representation 292, other techniques, such as a beep before and/or after the audio may be used, or an alternate audio may be used, such as having an indication of obsolescence spoken in a voice.

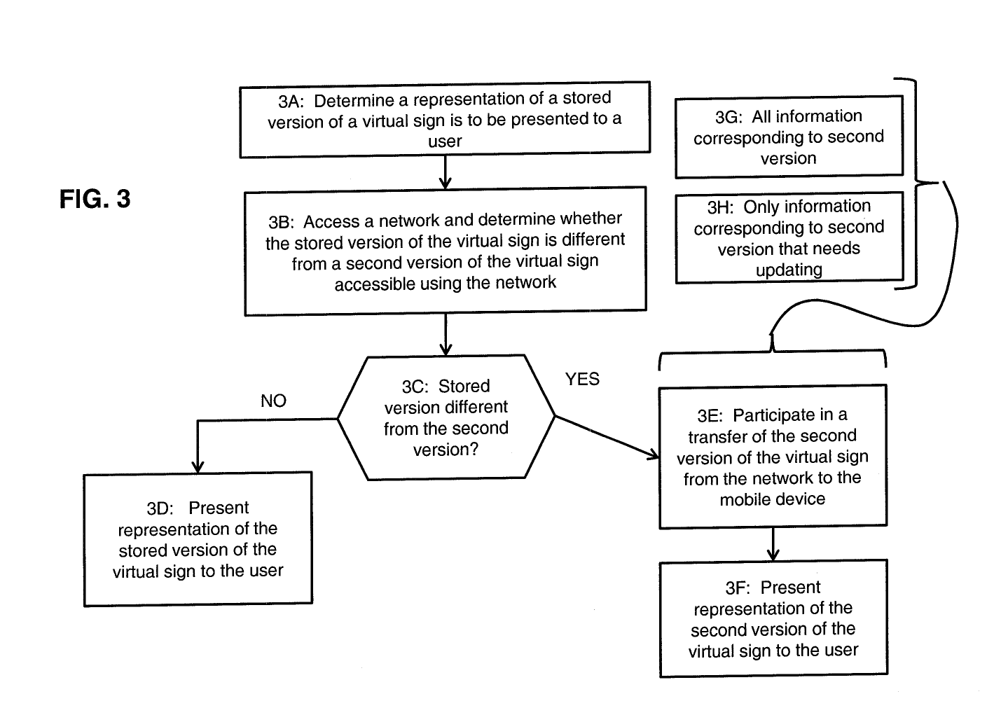

Turning now to FIG. 3, FIG. 3 is a flowchart of an exemplary method performed by a mobile device for access to and presentation of virtual signs. The blocks in FIG. 3 may be orchestrated by, e.g., sign retrieval 225 or some other control function (not shown). In block 3A, it is determined that a representation of a stored version of a virtual sign 270 is to be presented to a user. For instance, the location 221 and heading 222 might meet the ranges of the locations and headings stored in conjunction with the virtual sign 270. In block 3B, the mobile device 110 accesses a network (e.g., network 145) and determines whether the stored version 270 of the virtual sign is different from a second version 271 (e.g., a “master” version) of the virtual sign accessible using the network.

In block 3C, it is determined if the stored version 270 is different from the second version 271. Synchronization of a cache with a master copy is well-known in the art. Timestamps are typical. A given copy may also be uniquely identified by its checksum or cryptographic hash. If not (block 3C=NO), in block 3D, a representation of the stored version 270 of the virtual sign is presented to the user. This representation may include an audio representation 292, video representation 291, or both. If so (block 3C=YES), in block 3E, the mobile device 110 participates in a transfer of the second version 271 of the virtual sign from the network to the mobile device 110. Note that the transfer may include all of the information corresponding to a virtual sign 271 (block 3G) or only some of the information corresponding to a virtual sign 271 (block 3H). In block 3F, a representation of the second version of the virtual sign is presented to the user. This representation may include an audio representation 292, video representation 291, or both.

It is noted that blocks 3D and 3F are typically presented on “top” of data that is already being presented to a user. For instance, as shown in FIG. 1, a visual representation 190 of a virtual sign appears on top of a picture 112. Similarly, an audio representation 292 could be mixed with an existing audio stream being output, e.g., to speaker 265. However, this is not a requirement of the invention.

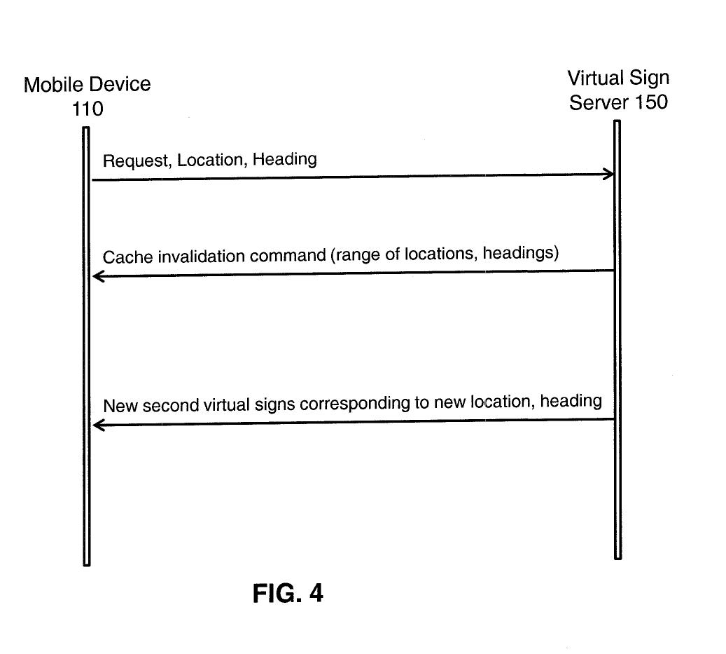

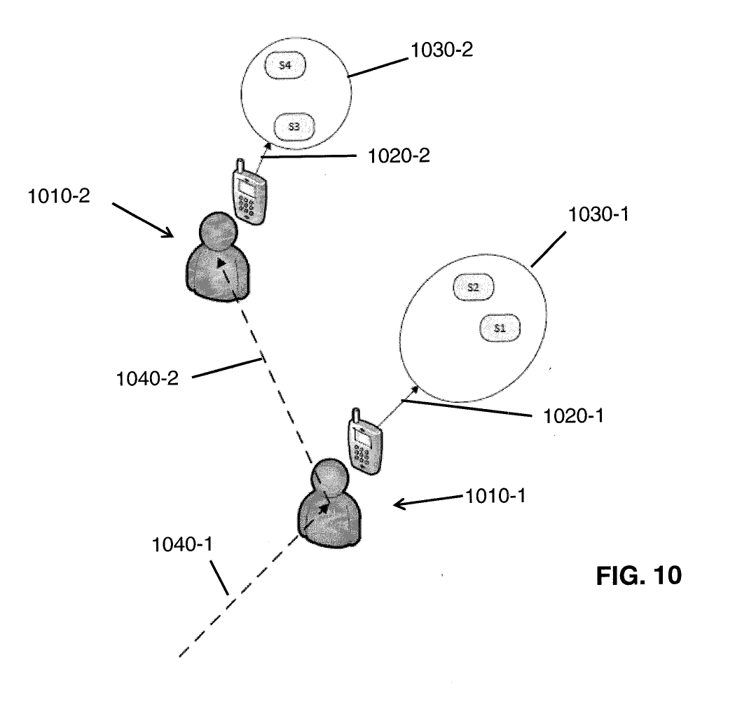

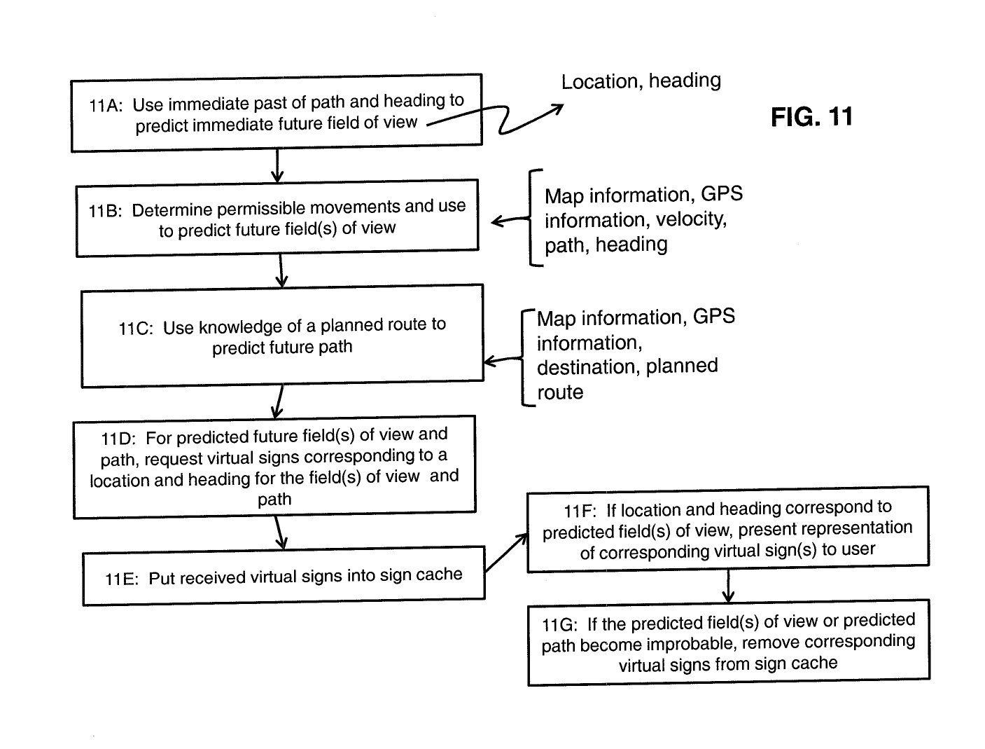

If it is known that many virtual signs 271 have changed on the server 150, the server 150 can send a cache-invalidation command to the mobile device, causing its sign cache to be either partially or wholly invalidated. This is shown in the messaging diagram of FIG. 4, where in response to a request containing a location and a heading from a mobile device 110, the server 150 responds with a cache invalidation command in a message. One circumstance where this is valuable is if the location 221 of the mobile device 110 is a new one, far removed from past locations, e.g., as in international travel. The command can specify a range of locations and headings (shown in FIG. 4) so that only cache copies of virtual signs within that range (or those ranges) will be invalidated, preserving the other cache contents for future use. Predictive algorithms in the sign retrieval block can track the location, velocity and direction of movement of the mobile device and, if a network is present, can proactively fetch virtual signs into the cache, anticipating their near-term use. See FIGS. 10 and 11 below. In the example of FIG. 4, the server 150, in response to the cache invalidation command, also sends virtual signs 271 to the mobile device 110 because of the new location 221 (e.g., and heading 222). In any case, if a network is present, sign retrieval 225 should query the server 150 to determine if there are any virtual signs relevant to the current location 221 and heading 222 of the device that do not have a cached copy in sign cache 230. These virtual signs 271 will be cached when they arrive from the sign server.

The operation of the sign cache 230 and sign retrieval 225 and sign server 150 have the ability to retrieve virtual signs 270 based, e.g., on geographic location 221. Topics concerning geographic information systems and their uses can be found in such books as “Introduction to Geographic Information Systems,” 5th edition, Kang-Tsung Chang, McGraw-Hill (2009), ISBN 0071267581.

As described above, the information defining a static virtual sign includes, but is not limited to, the sign shape, position and orientation (the normal to the sign face); the background image of the sign including its color and transparency, the text of the sign if any, and its color and any other information such as the sign's display priority with respect to other virtual signs. A given virtual sign may have any number of representations, depending on the size and rendering capability of the mobile device on which the representation is to be displayed and the national language of the user. Certain sign representations can provide easier access to users with visual deficiencies such as lack of visual acuity and colorblindness. A sign may have an audible content representation so that if the sign is selected by a user, the user can hear the sign content as spoken sounds. Signs need not be static but may have content or even shapes and backgrounds that change with time. Non-static signs may have representations needing significant storage capacity and taking significant time to communicate over a network, and local caching of these sign representations and anticipatory fetching of their representations into the cache may significantly improve responsiveness.

With this discussion of mobile device 110 considerations, it can be seen that actions taken on the sign server 150 will be reflected by the visual display or audio on a mobile device either immediately or with some delay. Thus actions to update, add and delete virtual signs 271 on the server 150 will be sufficient to ensure that the user sees only those virtual signs 271 that are relevant to the user's location 221 and heading 222, have been approved by any authorities, and contain no obsolete content or appearance without a cue to the viewer.

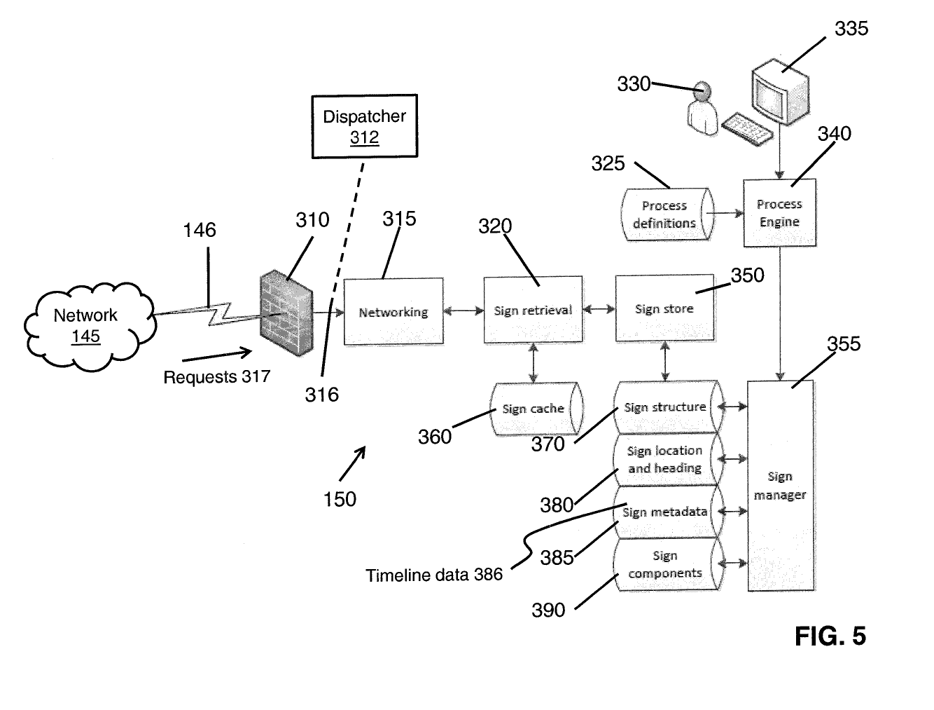

FIG. 5 shows exemplary server-side components, both hardware and software, of the virtual sign management system and connection to a network through other devices. First, an exemplary process is described by which sign requests from mobile devices 110 result in the transmission of pertinent virtual signs or data thereof to those clients.

To the left on the figure is seen a firewall 310 connected to a computer network 145, for example, the Internet, via link 146. Mobile devices 110 communicate through this network 145 to the virtual sign management system implemented by a server 150. Server 150 in exemplary embodiment includes the elements 315, 320, 325, 340, 350, 355, 360, 370, 380, 385, and 390. However, there may be situations where some of these elements are distributed over multiple servers 150. For instance, the sign retrieval entity 320 and sign cache 360 could be implemented on one server, with the sign store 350 and sign manager 355 could be implemented on another server.

The networking circuitry 315 connects, via network connection 316, to a firewall 310 in this example. The firewall 310 blocks all traffic except that pertinent to the authorized retrieval of virtual signs 271. Traffic that passes through the firewall 310 is handled, in a non-limiting embodiment, by a networking component (e.g., dispatcher 312) such as IBM's network dispatcher, which selects a server to handle a specific element of traffic on the basis of the ability of that server to provide service to the originator of the traffic. Thus, a network dispatcher allows large quantities of traffic (e.g., sign requests) to be allocated to as many servers as necessary to provide responsive service. IBM network dispatcher is described in “Network Dispatcher: A Connection Router for Scalable Internet Services,” G. D. H. Hunt, et. al., Journal of Computer Networks and ISDN Systems, vol. 30, Elsevier Science, Amsterdam, Netherlands, 1998.

Once passed through the firewall 310 and distributed by dispatcher 312, sign requests 317 traffic arrives at a sign retrieval entity 320. The sign retrieval entity 320 may be implemented, e.g., by software executed by one or more processors in the 150 server. A sign request 317 includes, e.g., a geographic location 221 and a heading 222, and is a request for sign data pertinent to that location 221 and heading 222. Note that the criteria used by dispatcher 312 to select a sign retrieval server 150 may be the geographic area served by that server 150 or some other criteria. When a sign request 317 arrives at the server 150, the sign retrieval entity 320 first checks to see if the server 150 has any signs in its sign cache 360 that satisfy the sign request 317. If so, the sign retrieval entity 320 retrieves sign data from the sign cache 360 and returns the sign data to the requester. The purpose of the sign cache 360 is to store sign data in a way that permits its fast retrieval.

Whether or not sign data pertinent to a given sign request exists in the sign cache 360, the sign retrieval entity 320 also queries the sign store entity 350 to see if there are any pertinent signs stored there, but not in the sign cache 360. If not, the sign request is satisfied. If so, sign data is retrieved from the sign store entity 350, stored by the sign retrieval entity 320 in the sign cache 360 and returned to the originator of the sign request 317. If the sign cache 360 is full, some sign data in that cache may be invalidated to make room for the incoming sign data.

Now, exemplary procedures by which virtual signs are managed are described: that is, how the data for new virtual signs becomes eligible to satisfy a sign request, and how data for old virtual signs becomes ineligible to satisfy a sign request. Note that because virtual signs 271 can change over time (e.g., their appearance can age or their content can change) the data supplied to a given sign request can depend on the time at which that request is received as well as on many other factors.

The techniques by which sign data becomes available to satisfy a virtual sign request includes the sign store entity 350 with associated exemplary data stores: sign structure 370, sign location and heading 380, sign metadata 385, and sign components 390. When a sign request 317 is received by the sign store entity 350 from the sign retrieval entity 320, the sign location and heading store 380 is consulted to determine which signs are relevant. For each relevant virtual sign, the sign structure store 370 is consulted to determine the various components of the sign (e.g., the sign shape, the sign background, the sign content and format) and the components are then retrieved from the sign components data store 390 (holding, e.g., the text, audio, images and/or video associated with a virtual sign). The combination of the sign structure from the sign structure store 370 and the sign components from the sign components store 390 makes up the sign data for a virtual sign 271 to be returned to the sign requester. it is noted that the elements 370, 380, 385, and 390 contain all of the information 272 corresponding to a virtual sign 271.

The sign manager component 355, which may be a software component of the sign store entity 350 or may be implemented in a separate server 150, has the responsibility to see that the sign structure store 370, location and heading store 380 and sign components 390 are correct, given the various factors that can affect the appearance of a virtual sign.

There are two general processes performed by the sign manager component 355. First, the sign manager component 355 is responsive to sign management processes running in the process engine 340 and potentially interacting with a human sign administrator 330 connected to the process engine 340 via a computer 335. Sign management processes are defined in the process definitions store 325. An example sign management process is the creation of a new virtual sign. The process engine 340 should assure that the sign is properly authorized; that any fees are or will be paid (or a process started to pay such fees periodically), and that the sign can be displayed in a manner useful to a mobile device user. All of the data needed to update the sign data stores 370-390 should be available. This process engine 340 interacts with data sources and authorization authorities not shown in the figure. If the sign is to be deployed, the process engine 340 then directs the sign manager component 355 to modify the contents of the various data stores 370-390 under its control so that the sign store entity 350 can retrieve this data in response to a sign request 317.

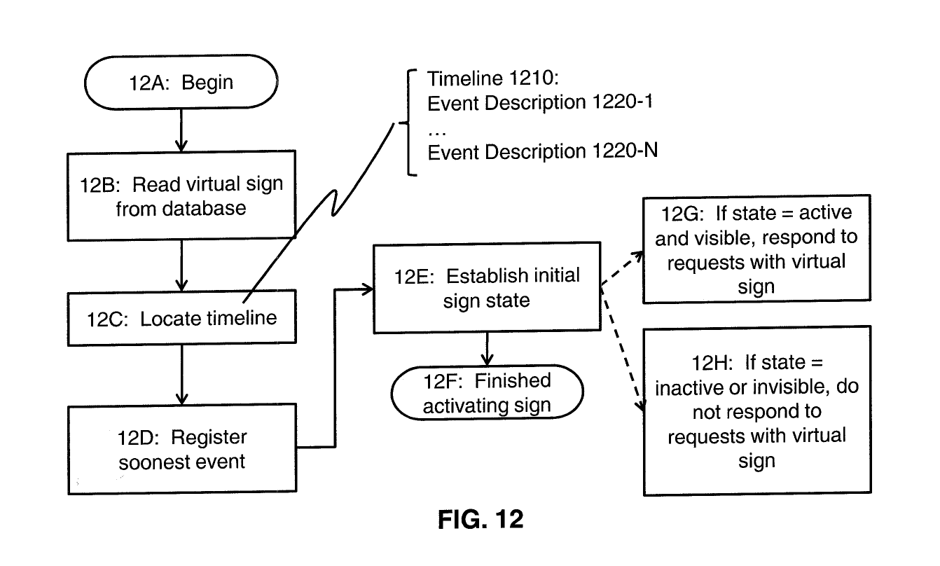

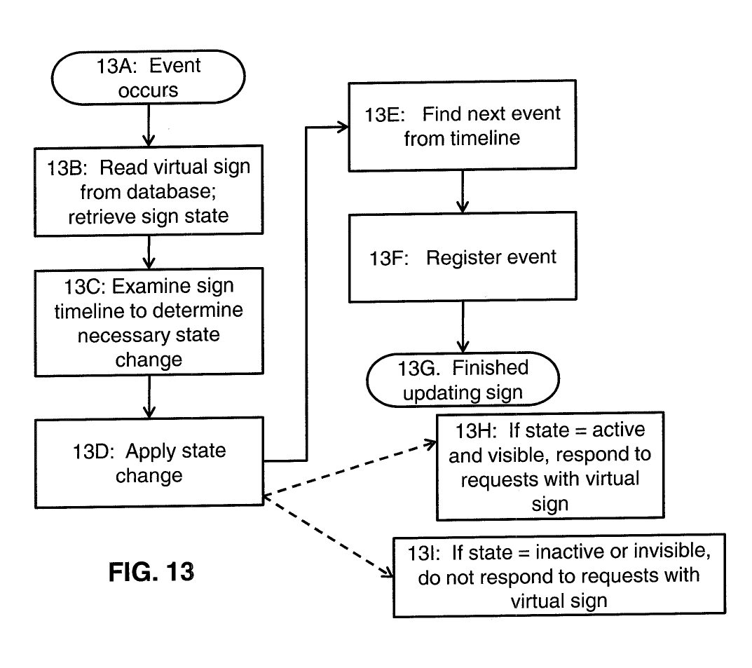

Second, the sign manager component 355 is responsive to sign metadata in sign metadata store 385 and to factors not shown, without any direction from the process engine 340. For example, a key factor is time. Sign metadata may define the sign lifetime (in timeline data 386) as a time at which the sign is first shown, an appearance aging profile, and a time at which the sign is to be taken down. The sign manager component 355 checks the current time against the sign metadata in timeline data 386 that characterizes the sign during lifetime of the sign and modifies the other sign data stores (structure, location and heading and components) appropriately. This is described in more detail in reference to FIGS. 12 and 13. Sign metadata in sign metadata store 385 may specify that there is a registered entity associated with the sign (e.g., a restaurant) such that the existence of that entity is a precondition to the sign being shown. Sign metadata may specify that the sign appearance changes with the time of day, or with weather conditions. The sign content itself may change with some factor. The mechanism of this change includes the sign manager component 355 being responsive to any collection of factors, also responsive to sign metadata, and capable of determining that said metadata specifies an alteration of sign appearance (structure, location, heading and/or content) responsive to one or more factors.

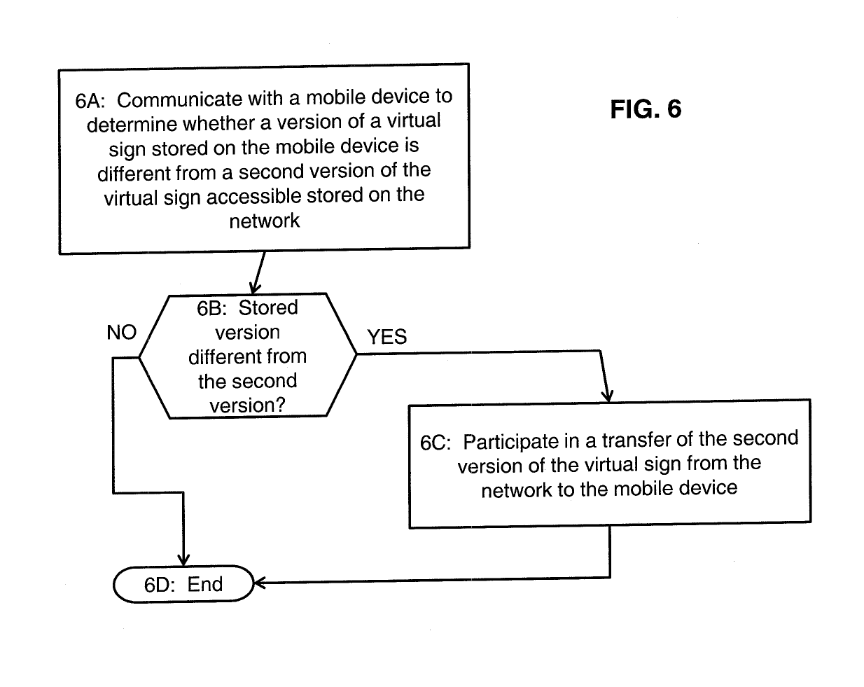

Turning to FIG. 6, a flowchart is shown of an exemplary method performed by a virtual sign server for providing access to virtual signs. In block 6A, the server 150 communicates with a mobile device 110 to determine whether a version 270 of a virtual sign stored on the mobile device 110 is different from a second version 271 of the virtual sign accessible stored on the network. In block 6B, it is determined if a stored version 270 is different from the second version 271. If not (block 6B=NO), the method ends in block 6D. If so (block 6B=YES), in block 6C, the server 150 participates in a transfer of the second version 271 of the virtual sign from the network to the mobile device 110. Techniques for retrieving virtual signs 217, such as accessing the sign cache 360 or the stores 370, 390, have been described above. After block 6C, the method ends in block 6D.

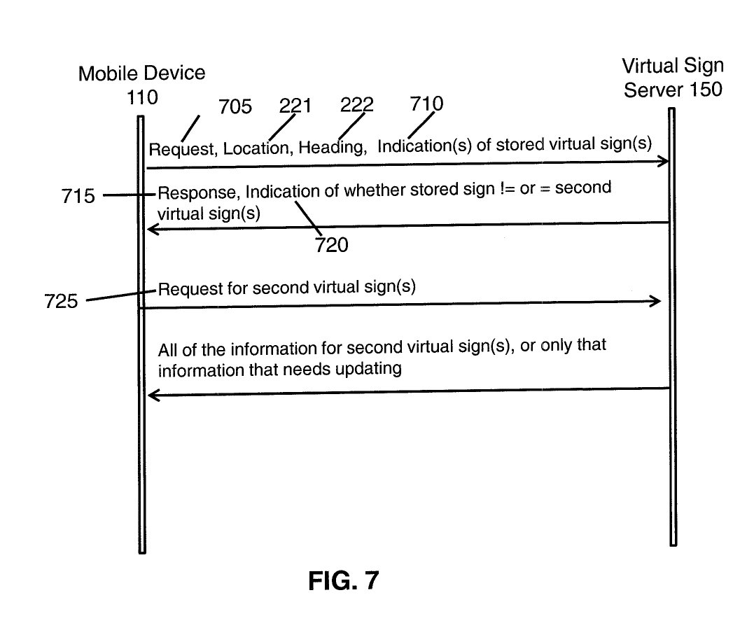

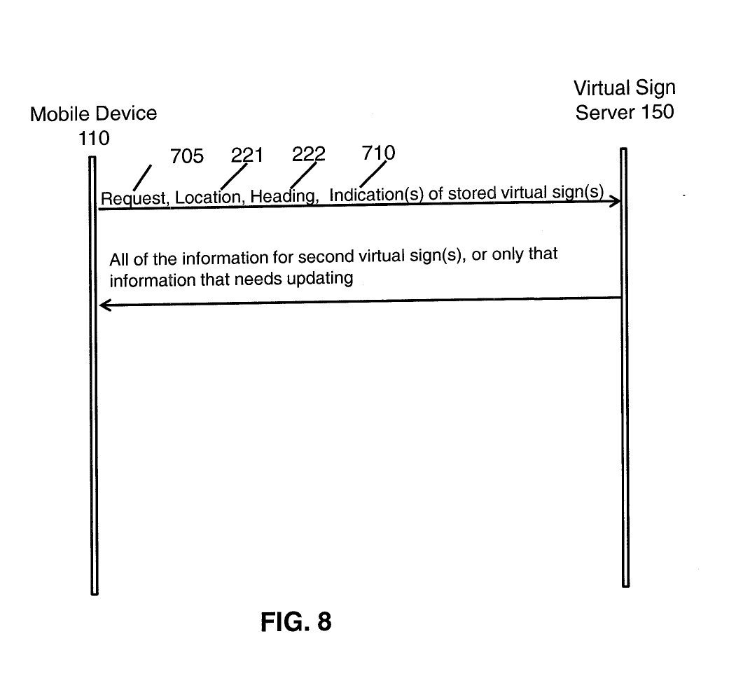

FIGS. 7 and 8 illustrate exemplary messaging diagrams between a mobile device 110 and a virtual sign server 150 and further illustrate possible actions taken in FIGS. 3 and 6. For instance, in FIG. 7, the mobile device 110 sends a request 705 including a location 221, a heading 222, and an indication 710 of a stored virtual sign 270 (or indications 710 of multiple stored virtual signs 270). The virtual sign sever 150 sends a response 715 that includes an indication 720 of whether the stored virtual sign 270 is different from (“!=”, not equal) or is the same as (“=”, equal) the second virtual sign 271 (that is, the “master” virtual sign). In response to the indication 720 indicating that the stored virtual sign 270 is different from (“!=”) the second virtual sign 271, the mobile device 110 sends a request 725 for the second virtual sign 271 (or second virtual signs 271) to the virtual sign server 150. It is noted that this request 715 may contain the indications 710 corresponding to the virtual signs 271 to be transferred. In response, the virtual sign server 150 sends all of the information for the second virtual signs 271 or sends only that information that needs to be updated.

In FIG. 8, in response to the indication 710 of a virtual sign 270 indicating the virtual sign 270 is different from the second virtual sign 271, the virtual sign server 150 sends all of the information for the second virtual signs 271 or sends only that information that needs to be updated. In this example, the response 715 and the request 725 are skipped.

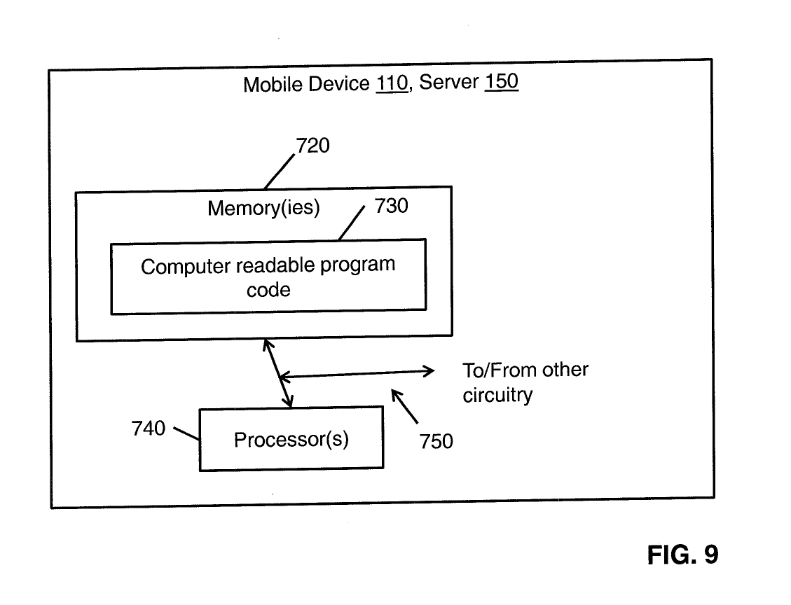

FIG. 9 illustrates a portion of a device suitable for the mobile device or virtual sign server. For the examples where software is used to perform entities in the mobile device 110 or server 150, the circuitry shown in FIG. 9 may be used. For instance, the sign retrieval 225 in the mobile device 110 might be implemented via software. In the server 150, the sign retrieval entity 320 was another example of an entity that might be performed via software. For these entities, they may be embodied in computer readable program code 730 in one or more memories 720. The one or more processors 740 execute the computer readable program code 730 and cause the corresponding mobile device 110 or the server 150 to perform the actions defined by the computer readable program code 730. The one or more memories 720 and one or more processors 740 are interconnected by one or more buses or networks 750. For instance, as described above, the sign manager component 355 may be executed on a set of processors 740, while the sign store entity could be executed on a second set of processors 740 and these two sets could be interconnected by a buses/links 750 such as Infiniband (a switched fabric communications link). Network connections such as Ethernet may also be used (see networking circuitry 210 of FIGS. 2 and 315 of FIG. 3) and connected to the network 750.

Now that the basics of operations for virtual signs have been described, additional exemplary embodiments are described. As described above, a mobile device can track the location, velocity and direction of movement of the mobile device and, if a network is present, can proactively fetch virtual signs into the cache.

FIG. 10 illustrates movement of a user through two different positions 1010-1, 1010-2 and the representations of different virtual signs for the different positions. With respect to this figure, a user is shown in the two successive positions 1010. The path 1040 is shown by dashed arrows. It can be seen that the user has turned left and in the second position 1010-2, the field of view 1030-2 (indicated by an oval) of his or her handheld mobile device is in a slightly different heading 1020-2 than the field of view 1030-1 (with its heading 1020-1) was at the first position 1010-1. Note that the field of view 1030 is not necessarily in the direction of the path 1040. The field of view 1030 is in the direction of the path 1040-1 in the first position 1010-1, but in the second position 1010-2, the field of view 1030 is to the right side of the path 1040-2. The ovals contain visual representations of virtual signs S1-S4, visible at the corresponding position 1010 and with the heading 1020 shown. That is, virtual signs S1 and S1 are visible via their representations at the position 1010-1 and the heading 1020-1, while virtual signs S3 and S4 are visible via their representations at the position 1010-2 and the heading 1020-2.

Prediction of the field of view 1030 enables proactive fetching of virtual signs. If the prediction has high confidence, then the fetching of virtual signs that are able to be seen (and/or heard) in that field of view 1030 is productive; if the prediction is erroneous, then proactive virtual sign fetching is at best unproductive and at worst counter-productive, because of bandwidth restrictions and charging (e.g., for bandwidth). That is, fetching of a virtual sign may postpone the fetching of another virtual sign. If the first fetching is due to an erroneous prediction and the second fetching is needed, it is possible that the user will miss the second sign because the second virtual sign will be fetched too late to be seen as the user moves on. Also, if the handheld wireless device is subscribed to a service with limits on the amount of data that can be accessed per unit of time, or where each unit of data transferred incurs a charge, there may be a cost penalty for erroneous proactive fetching of virtual signs. Thus, it is important to proactively fetch virtual signs but not to do so erroneously.

One method (see FIG. 11) of prediction operates over three different timeframes. In a first (short) timeframe (block 11A), information about the immediate past of the path of the user (via the handheld mobile device) and the immediate past of the heading of their handheld mobile device is used to determine a prediction of the immediate future field of view 1030 for the user, and thus of the signs that will be relevant for that field of view, so that those virtual signs can be proactively fetched. The path may be determined by multiple locations (e.g., by drawing a line through multiple locations). It is noted that a field of view 1030 may be defined by, e.g., a location and a heading. Such a short time frame may be, e.g., tens of seconds to several minutes.

In a second (longer) timeframe, knowledge of the permissible movements of the user relative to the surrounding area is incorporated. For example, if the user is on a city street moving in the direction of that street (e.g., and not perpendicular/away from the street), only fields of view from a straight path are likely, whereas if the user is at an intersection the path may change direction. That is, the knowledge is used to determine permissible movements and use these permissible movements to predict the future field(s) of view (block 11B). Such knowledge may be determined from, e.g., map information, GPS information, velocity of the mobile device, path 1040 of the mobile device, and heading 1020 of the mobile device. The longer timeframe may be from several minutes to several tens of minutes (e.g., depending on the velocity).

In the third (longest) timeframe, knowledge of the route planned (if any) for the user can be used to predict the future path of the user (block 11C). Knowledge of the planned route may be made using map information, GPS information, and a planned route (e.g., as provided to a GPS application). If no route planning has been performed, then knowledge of the immediate destination of the user can be obtained from their personal scheduler or from other data available to the handheld mobile device. It may also be advisable to initiate a route planning activity from the current position of the user to the known destination so as to have a prediction of the path. This prediction can be updated if the user makes unexpected choices in the route taken. The longest timeframe can be from, e.g., several minutes to several (or many) hours.

In block 11D, for any predicted field(s) of view and path, the mobile device requests from the server the virtual signs corresponding to a location and heading for the path. For instance, the messaging in FIG. 4 could be used for a specific location and heading as determined from the predicted field(s) of view and path.

It should be appreciated that the prediction of any field of view or path could be associated with a likelihood estimate. Highly likely predicted fields of view will cause proactive virtual sign fetching; less likely predicted fields of view will cause proactive virtual sign fetching if the penalty for so doing (e.g., postponement of the fetching of more likely virtual signs, data charges) is tolerable. In the method of prediction described in FIG. 11, the likelihood of correct prediction declines as the length of the timeframe increases.

In block 11E, virtual signs received from the server are placed into the sign cache (e.g., sign cache 230 shown in FIG. 2). In block 11F, if the current location and heading of the mobile device corresponding to one of the predicted fields of view, representations of any corresponding virtual signs will be presented to the user on the display. Presentation of the virtual signs to the user has already been described above.

In block 11G, if the predicted field(s) of view or predicted path (and therefore the field(s) of view corresponding to the predicted path) become improbable, the corresponding virtual signs are removed from the cache. For instance, if the predicted path extended along the path 1040-1 in FIG. 10, once the turn to the second path 1040-2 was made, any fields of view that corresponded to the extension along the path 1040-1 could be removed from the cache, as these fields of view become improbable.

Referring now to FIG. 12, a flowchart is shown of an exemplary method performed by a virtual sign server for activating a virtual sign. FIG. 13 also shows a flowchart of an exemplary method performed by a virtual sign server for changing a virtual sign. With respect to these figures, there are two parts to what should be done: activating a sign and changing a sign. FIG. 12 concerns activating a sign, and this is performed for each sign at the time that sign becomes managed.

Each virtual sign includes, in an exemplary embodiment, a timeline 1210 (e.g., in timeline data 386 of FIG. 5), which is a sequence of events characterizing the sign over its lifetime. Typically, the timeline is implemented as part of a virtual sign on the sign server, but typically is not implemented as part of a virtual sign on a mobile device. However, the instant invention is not limited to implementing a timeline only on the sign server. A timeline can be represented, e.g., as an XML document consisting of a sequence of event descriptions 1220, such as what an event is (typically a sign state transformation), the time of occurrence of the event and perhaps other information. The sign is not necessarily visible after the sign is activated. The last event in life of the sign is typically its deactivation, e.g., removal from management.

Each event in a sign timeline may include a specification of the state of the virtual sign just after the event occurs. For example, a given virtual sign may advertise a sale at a given place. When a representation of the virtual sign first appears, the contents of the representation would say that a sale will take place and give information about the sale. Then, at the time of the sale, the representation would change to say that a sale is taking place. After the sale is over, the representation would change again to say that the sale is over, and after some time elapses the sign would cease to appear. Four exemplary events have thus been identified in the sign timeline: activation of the sign, the change to the sign as the sale is in process (including its first appearance), the change when the sale is over, and the sign deactivation.

FIG. 12 concerns the sign activation. This process begins when a sign enters active management (block 12A), perhaps contingent on the payment of a fee and the approval of the sign by a licensing authority (described in more detail below). At this time, the virtual sign can be found in the database (e.g., sign store 350 in FIG. 3), having been placed there by some process not shown. In block 12B of the process, the virtual sign is read from the database. Then the timeline 1220 (include event descriptions 1220-1 through 1220-N in this example) of the virtual sign is located (block 12C) from the virtual sign and the soonest event (i.e., the event closes in time to the operation of locating the timeline) in that timeline located. This event is then registered (block 12D) with the sign management server 150 (e.g., with the sign manager 355 of FIG. 5). After that, the initial state of the sign is established in block 12E. This initial state may specify the location and heading of the sign, its content and appearance, transparency, visibility and many other attributes (e.g., see information 272 of FIG. 2). Once this initial state is established, the sign is activated and the process completes (block 12F).

It is noted that block 12E may cause the sign server to provide the virtual sign to a mobile device in response to a request for signs at a particular location. That is, if the initial sign states are active and visible (as examples; could also be, e.g., just active or just visible), the sign server will use the virtual sign for responding to requests. This occurs in block 12G. By contrast, if the state is a different state (e.g., inactive or invisible,) the sign server would not provide (block 12H) the virtual sign to a mobile device in response to a request for signs at a particular location. That is, if the initial sign state is inactive or invisible (as examples), the sign server will not use the virtual sign for responding to requests.

The sign server 150 in an exemplary embodiment uses techniques from event-driven programming, as described, for example, in the website c2.com/cgi/wiki?EventDrivenProgramming. The server may contain a polling loop that examines the time of day and inspects the list of events for any whose time is the same or less, or incorporates a periodic timer interrupt whose handler inspects a sorted list of events for the same condition (the time is the same or less than the current time). When the condition is satisfied, FIG. 13 is executed.

When a sign event occurs (block 13A), the virtual sign and current sign state is retrieved from the database (block 13B). The definition of the current event specifies how the state of the sign changes at the time of occurrence of the event. The sign timeline is examined to determine a necessary state change in block 13C. This state change is applied (block 13D) so that the current state of the sign changes. This state change then causes any cached virtual signs to be invalidated or to be updated. After the state change is accomplished, the next event is retrieved from the timeline (block 13E) and registered with the sign management server (block 13F) and the process completes (block 13G).

It is noted that block 13D may cause the sign server to provide the virtual sign to a mobile device in response to a request for signs at a particular location. That is, if the initial sign states are active and visible (as examples; could also be, e.g., just active or just visible), the sign server will use the virtual sign for responding to requests. This occurs in block 13H. By contrast, if the state is a different state (e.g., inactive or invisible,) the sign server would not provide (block 13I) the virtual sign to a mobile device in response to a request for signs at a particular location. That is, if the initial sign state is inactive or invisible (as examples), the sign server will not use the virtual sign for responding to requests.

Note that it is possible that the event registered may concern a sign other than the one whose state is changed, allowing the timeline for one sign to affect another sign. That is, there could be relationships between multiple virtual signs. For instance, a store could have a storefront sign and a sale sign. The two signs could be completely independent. However, the sale sign could also be a subsidiary of the storefront sign, and the sale sign would not have its own timeline. Thus, an event to cause the sale sign to be deactivated (or not visible) might not affect the storefront sign, but deactivation of the storefront sign would affect the sale sign if the sale sign is a subsidiary of the storefront sign. Another example includes signs for construction of a road and accompanying detour signs. The signs for construction and detour could be completely separate. Alternatively, the signs for the detour could be related to and be subsidiaries of the sign for the construction. That is, the detour signs would not have their own timeline and instead have the same timeline as the construction sign.

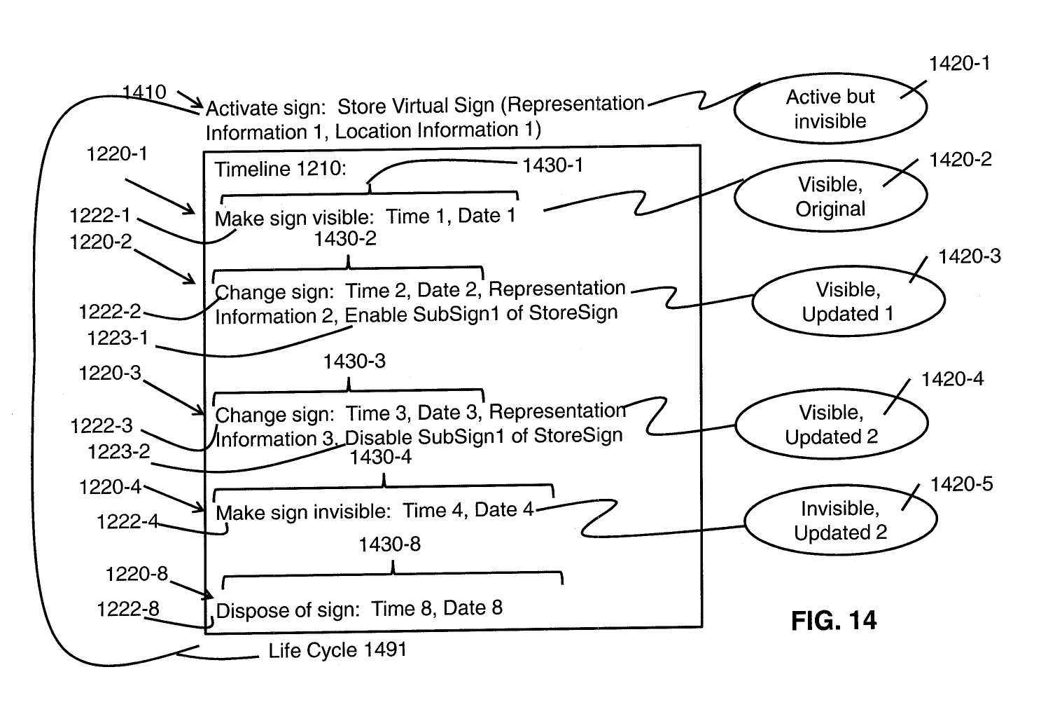

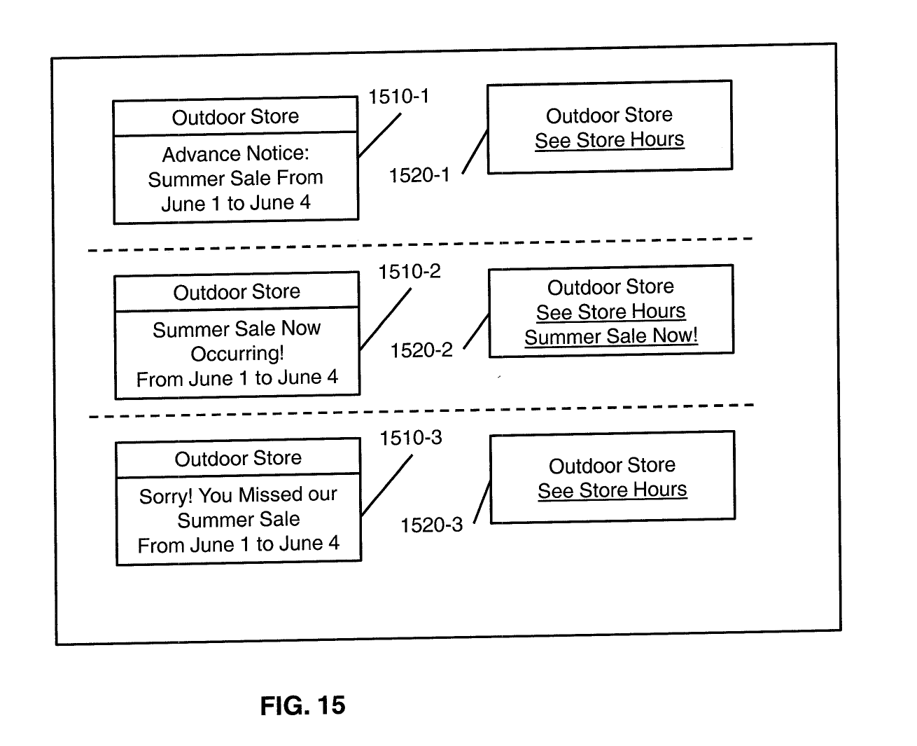

A simple example is shown in FIGS. 14 and 15. FIG. 14 is an example of a timeline and its associated states. FIG. 15 shows examples of two virtual signs corresponding to FIG. 14. Reference 1410 in FIG. 14 shows an example of a result of FIG. 12, where a virtual sign is activated. This results in a state 1420-1 of active but invisible. The virtual sign includes Representation Information 1, which concerns how the virtual sign is to be represented to a user. In the example of the virtual sign 270 in FIG. 2, the Representation Information 1 could include, as examples (see information 272 of FIG. 2) sign shape, position, orientation, background image (e.g., color and transparency), text, audio, foreground image, video, and/or executable file(s). The Location Information 1 could include as examples (see information 272 of FIG. 2) location ranges and heading ranges.

The timeline 1210 then includes event descriptions 1220-1 through 1220-4. When FIG. 13 is performed, the event 1430-1 that occurs is that a current time is equal to or greater than Time 1, Date 1. In the example shown in FIG. 14, the events also include some indication of a command 1222-1. For instance “Make sign visible” is included as a command 1222-1 part of event 1430-1. Also, the events 1430 can solely include time information, and the rest of the event description could include any commands or other data used to modify a state of the virtual sign.

The current state retrieved in block 13B of FIG. 13 is state 1420-1. In this example, the event description 1220-1 does not include any additional data to be applied to the visual sign and a command 1222-1 is “Make sign visible”, so the state change applied (block 13D) is simply to make the visual sign (e.g., a representation thereof) visible using the original information (Representation Information 1 and Location Information 1). It is noted that making a virtual sign “visible” means that a representation of the virtual sign can be presented to a user, even if the representation is strictly audio. That is, block 13H would be performed and the virtual sign would be transferred to mobile devices in response to requests for virtual signs. The state is updated to state 1420-2, visible and original. The next event in the timeline 1210 is event 1430-2 (e.g., occurring at least at Time 2 and Date 2) and this is registered in block 13F. The timeline 1210 concerns a virtual sign for customers on certain “mailing” lists for the “outdoor store”. A representation 1510-1 is shown in FIG. 15, as is a representation 1520-1 of a generic store sign for the outdoor store (where “See Store Hours” is a hyperlink). The representation 1520-1 of the generic store sign is presented to those individuals not on the mailing list.

FIG. 14 also shows another option of how an event 1430 in one timeline can affect an event 1430 in another timeline. That is, the “Enable Subsign1 of StoreSign” command 1223-1 causes an event to be registered (using Time 2, Date 2) in the timeline (not shown) for the virtual sign 270 for the generic store sign. This is explained in more detail below.

At or after Time 2 and Date 2, the state change is applied (block 13D) by applying Representation Information 2 to the information for virtual sign 270. For instance, certain text changes from “Advance Notice: Summer Sale From June 1 to June 4” to “Summer Sale Now Occurring! From June 1 to June 4”. See the representation 1510-2. The state is modified to state 1420-3, and the next event 1430-3 is registered. It is noted that the “Disable SubSign1 of Store Sign” also is registered as another event for the generic store sign. In this example, “Change sign” command 1222-2 indicates information in the event description 1220 is to be applied to the virtual sign.

Note that the event description 1220-2 also includes the “Enable SubSign1 of StoreSign” command 1223-1. This command is entered in the timeline (not shown) for the generic store sign and causes another state change to occur for the virtual sign 270 corresponding to the representation 1520-1, so that “Summer Sale Now” is added to the representation 1520-1 of the generic store sign to create the representation 1520-2.

At or after Time 3 and Date 3, the state change is applied (block 13D) by applying Representation Information 3 (according to the command 1222-3) to the information for virtual sign 270. For instance, certain text changes from “Summer Sale Now Occurring! From June 1 to June 4” to “Sorry! You Missed our Summer Sale From June 1 to June 4”. See the representation 1510-3. The state is modified to state 1420-4, and the next event 1430-4 is registered. Additionally, the “Disable SubSign1 of StoreSign” command 1223-3 causes (after entry into the timeline for the generic store sign) the “Summer Sale Now!” text to be removed from the representation 1520-2 to create the representation 1520-3 for the generic store sign.

In response to the current time and date being at least the same as Time 4, Date 4 (respectively), the representation 1510-3 is made invisible (i.e., the representation is not shown to mailing list subscribers and block 13I is performed) as per the command 1222-4. The state is updated to state 1420-5.

It is noted that Representation Information 2 and 3 may be stored on, e.g., the server as, e.g., part of sign components 390 of FIG. 5. Or the Representation Information 2 and 3 can be stored as part of the information 272 that makes up a virtual sign 270/271, and the entity producing representations would be programmed to determined which of the Representation Information 2 or 3 (or also Representation Information 1) is to be used at which times.

The example of FIGS. 14 and 15 used two virtual signs 270 and their representations 1510, 1520 linked through Event descriptions 1220. However, as described above, the main store sign could be the virtual sign 270 corresponding to the representation 1510 and therefore a timeline for the sale sign would be part of the timeline 1210 for the main store sign. Additional embodiments are possible, such as having the times and dates cover ranges instead of single instances of time.

It is noted that the states 1420 might not be explicit states as shown. Instead, the state of the virtual sign 270 could be determined by its corresponding information 272 (e.g., sign shape, position, orientation, background image (e.g., color and transparency), text, audio, foreground image, video, executable file(s), location ranges, heading ranges, other data). A state could be indicated in such information 272, and such state could be indicated as activated, visible, invisible, and deactivated as examples. Other states are also possible. The states 1420 shown in FIG. 14 are useful to visualize the life cycle of the virtual sign 1420. One state not shown in FIGS. 14 and 15 is the deactivated state. Virtual signs that are deactivated may be stored for a certain time period and then removed or removed upon deactivation.

As described above, virtual sign has a life cycle indicated in FIG. 14 by life cycle 1491. The command 1222-8 in the event description causes the sign to be disposed of in the event 1430-8. That is, the sign is created (e.g., 1410), has a life, and is then disposed of (e.g., in response to command 1222-8 implemented at Time 8 and Date 8). Disposal can be caused by direct action (e.g., “kill” the sign) or indirect, e.g., dissipate and make the sign slowly fade away. More particularly, a registered event can be an event of dissipation, wherein changes would be applied to the virtual sign so that its visual representation would dissipate from an initial opacity to a clear opacity over a predetermined time period. At the end of the predetermined time period, the virtual sign is disposed of. The advertiser can change the state (e.g., fading) by providing additional revenue. For instance, as the sign begins to fade, the sign could be made visible again by an influx of revenue. That is, the visual representation of the sign would be changed such that the visual representation occurs at the initial opacity.

It should also be noted that FIGS. 12 and 13 can be performed by either client (e.g., a mobile device) or server. That is, the information for a virtual sign 270 can also include a timeline 1210 for the virtual sign 270 on the mobile device (see FIG. 2). In this embodiment, blocks 12G and 13H would allow a virtual sign to be presented to a user; blocks 12H and 13I would prevent a virtual sign from being presented to a user. In another embodiment (as described previously), the client queries the server (as described above) and the server provides the current virtual sign 271, depending on state(s) of the virtual sign.

A description has been provided concerning how virtual signs can be managed; in particular, how signs are activated and how events on the timeline of the sign can change the state of the sign. Sign state includes the position and heading in space of the sign, background and content of the sign and many other attributes (see, e.g., the information 272 for virtual sign 270 in FIG. 2).

Localities (e.g., towns, cities, districts, road rights-of-way) may desire to control the virtual signs that appear within their jurisdictions, as they control the physical signs that so occur. Virtual signs can be determined to be in a given jurisdiction through comparison between their locations and the boundaries of the jurisdiction. In some cases, there may also be a desire to control virtual signs visible (e.g., through their representations) from a jurisdiction, and such signs can be determined by determining visibility of such signs from each point on the boundary of a jurisdiction. The locality may choose to grant or withhold its authorization based on the sign position, the sign size, heading, content or any other attribute of the sign.

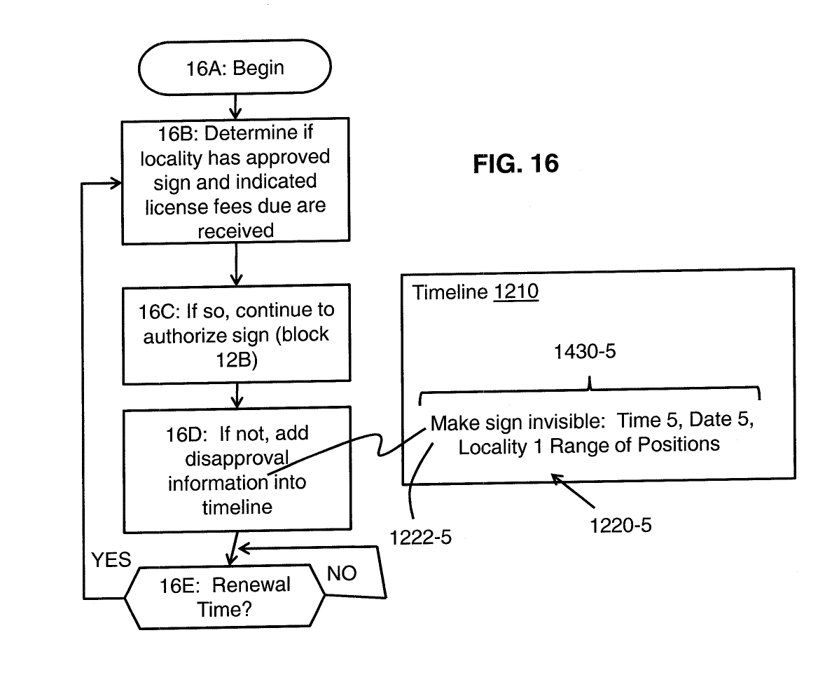

Provision can be made during the sign activation process (previously described) to see if locality approval has been obtained and fees due have been acknowledged. For instance, FIG. 16 is a flowchart of an exemplary method performed by a sign server to allow a locality to license virtual signs to be presented within the boundaries of the locality. The method begins in block 16A, which occurs before block 12A of FIG. 12 in an example. In block 16B, the sign server determines if a locality has approved a virtual sign and has indicated fees due are received. If so (block 16C), then block 12B of FIG. 12 is performed. If not (block 16D), disapproval information is added into the timeline 1210 for the virtual sign. For instance, the disapproval information can take the form of an event description 1220-5 having a command 1222-5 of “Make sign invisible” at Time 5, Date 5 in event 1430-5. The event description 1220-5 further includes Locality 1 Range of Positions, which would include some range of positions that define the area controlled by Locality 1. Time 5 and Date 5 could be assigned to be earlier than the time and date when the disapproval information is added to the timeline 1210, or the Time 5 and Date 5 might not be included, which would indicate that the sign should be made invisible immediately. It is also noted in block 16C, that a similar event description 1220 may be added with a future time and date, e.g., to cause the sign to expire in the future if no reauthorization is performed.

An exemplary embodiment of the instant invention also permits periodic review by the locality to re-authorize the sign. For instance, in block 16E, the sign server can determine that it is a renewal time and then execute blocks 16A-16D again. An exemplary embodiment of this capability is to include locality authorization in the state, and to introduce events in the sign timeline which cause that authorization to expire (e.g., as discussed above in reference to block 16C and entry of future time and date). When such an event occurs in the sign timeline, the sign visibility will be changed to the “invisible” state and this prevents the sign from being viewed. When local authorization is received, the event signaling expired authorization will be removed from the sign timeline or replaced by another event signaling expired authorization but occurring in the future. Thus the mechanism enforcing valid authorization of a sign is based on events in the sign timeline and a component of sign state.

Note that authorization or re-authorization of a sign by a locality may affect the sign in other ways. For example, if the sign is viewable from two localities and subject to authorization by both of them, and only one authorization is received, the sign state may be altered so that the sign is viewable only from the locality authorizing its viewing and not from the locality not so authorizing. Signs may be authorized only for viewing in the daytime or only at night, or only at certain times of the day. In each of these exemplary cases, the mechanism controlling the visibility of the sign employs events in the sign timeline.

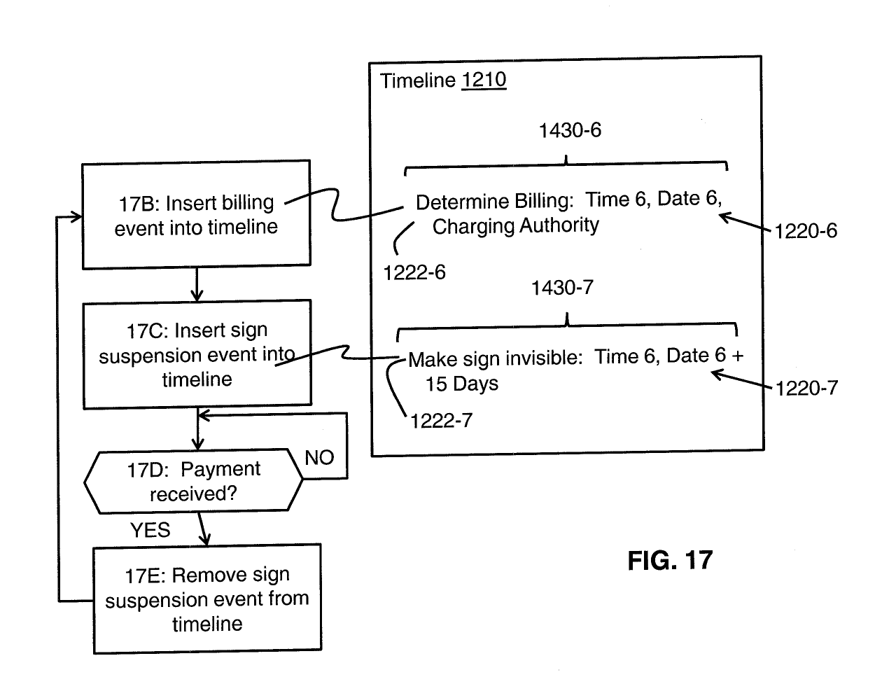

The preceding discussion concerning sign licensing is couched in terms of a license fee which may be required in order to authorize or re-authorize a sign. An alternate charging model for virtual signs is one in which a fee is charged by some charging authority to a sign owner when the sign has been visible for some period of time, or when the sign is viewed. In the former case, analogous to reauthorizing a license, an event can be inserted into the sign timeline that triggers billing activity by an authority. For example (see FIG. 17), if sign display is charged for by the month, the charging authority could insert (block 17B) an event 1220-6 in the sign timeline, that event occurring one month (e.g., at Time 6, Date 6) from the initial sign display, notifying (via a “Determine Billing” command 1222-6 of the event 1430-6) the charging authority (e.g., “Charging Authority” in the event description 1220-6) to present a bill. A second event 1222-7 could be inserted (Block 17C) in the sign timeline 1210 suspending the visibility of the sign 15 days after the event notifying the charging authority. This is illustrated by Time 6, Date 6+15 Days and the command 1222-7 of “Make sign invisible” in the event 1430-7. If the charging authority receives payment in response to its bill (block 17D=YES), the charging authority will request (via sign server 150) removal of the sign suspension event 1430-7 in block 17E. If no payment is received, after Time 5 and Date 5+15 days, this second event 1430-7 will suspend the visibility of the sign. This example looks at only a single instance of one month, but the insertion in block 17B of the billing event would typically be periodic.

In another aspect of the current invention, the sign is created to have a release time and distribution. Another competitor may bid up the price and supplant the scheduled sign for a business, essentially ‘bumping’ (i.e., supplanting) the sign. That is, the sign of the competitor is shown and not the original sign if the remuneration meets some predetermined criteria (e.g., an amount). One way to do this is to add in an event 1430 that would supplant the sign for the business by replacing the virtual sign of the business with the virtual sign of the competitor. Another way to perform this supplanting is to assign a first geographical area to the competitor's sign and limit the geographical area of the original sign to an area that does not include the first geographical area. These steps could be performed through appropriate insertion of events 1430 in each of the timelines 1210 for the virtual signs. Another technique to enable this supplanting is to dispose of or inactivate (via an event 1430) the original virtual sign and activate (via an appropriate event 1430) the competitor's sign.

Additionally, a sign might contain product placement, say a bottle of soda, and advertisers can bid to have their brand appear virtually on the bottle for the life of the sign or for some period. Advertisers subscribe to sign creation events, and are notified when a sign is created and scheduled to go live. At that time, they can bid for product placement or the time/space ‘slot’, much like advertisers do in, e.g., Superbowl ads or ads for particular shows/time slots. This can be performed by modifying the timeline 1210 of a visual sign (e.g., with a visual representation of a bottle) with data for the brand (e.g., data that modifies the visual representation of the bottle to place brand information in correct location(s)).

The case of usage-based charging for signs is similarly addressed by exemplary embodiments of the instant invention. This will be described first in the absence of a sign cache in the handheld device, and then elaborated to provide for such a cache.

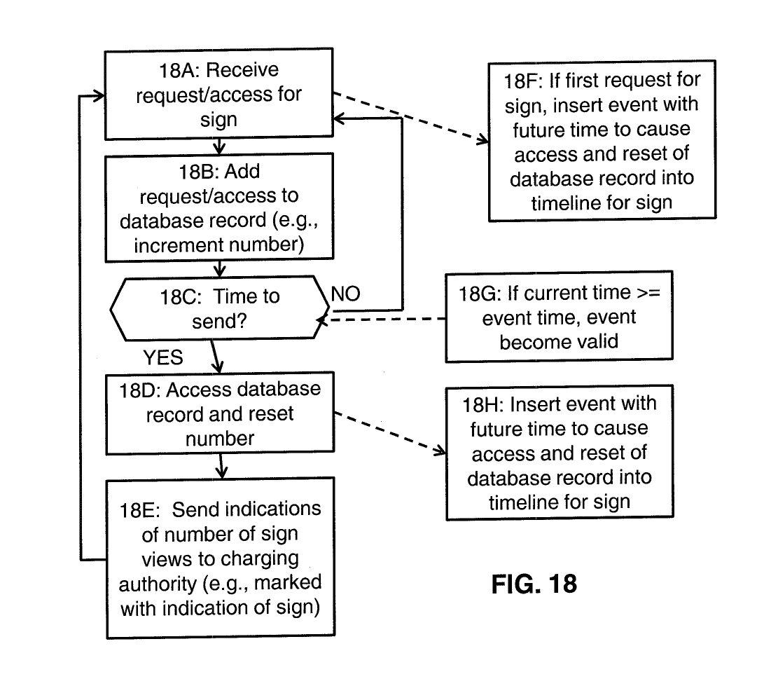

Without a sign cache, the handheld device is in communication with the sign server to retrieve visual signs for signs that are viewable from the current position and heading of the device. Each visual sign request and access (see FIG. 18, block 18A) can be counted in a database record (block 18B) designed to record the number of sign views. Periodically (say monthly) (block 18 C=YES) these counts can be accessed and reset (block 18D). The number of sign views can then be forwarded (block 18E) to the charging authority to facilitate the preparation of a (usage-based) bill. The event that accesses and resets the database record (at the sign server) can be inserted in the timeline of the sign, using the techniques presented above. For instance, in block 18F (performed between blocks 18A and 18B), if this is the first request for the sign, the sign server inserts an event 1430 (and its corresponding event description 1430) with a future (e.g., periodic) time to cause access and reset of the database record into the timeline for the sign. In block 18G, once the current time is greater than or equal to the event time, the event 1430 becomes valid (e.g., block 18C=YES but block 18C=NO otherwise) and block 18D is performed as part of the event. In block 18H, another event is inserted in the timeline with a future (e.g., periodic) time to cause access and reset of the database record.

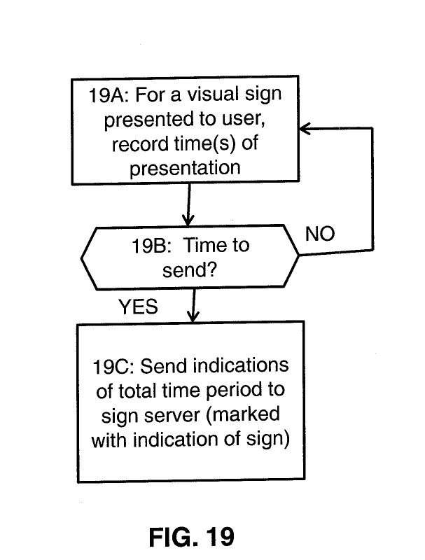

It may be desired by a charging authority or other authority to know not only how often a given sign is viewed but for what duration. To provide for this, the mobile device might record (block 19A of FIG. 19) the time that a sign is first displayed and the time that the sign is no longer displayed, and then to transmit (block 19C) the time interval and perhaps the start time of that interval in a message to the sign server together with an identification of which sign the message pertains to. This information could be transmitted for each viewing of the sign or (per block 19B) at some periodic interval. This information can be saved at the sign server in one or more database records, either in summary (aggregate) form or as one record for each interval. The aggregate form facilitates charging the owner of the sign for the duration of viewing; the complete record of sign viewing facilitates various analyses to determine the effectiveness of the sign. For example, a frequently-viewed sign with significant content experiencing very short average viewing times may be presenting an information overload to its viewers.

As can be seen by the preceding discussion, it is equally possible to combine licensing and charging, such that a locality can control the signs viewable within its jurisdiction and a charging authority can bill for the sign in various ways, including usage-based charging.

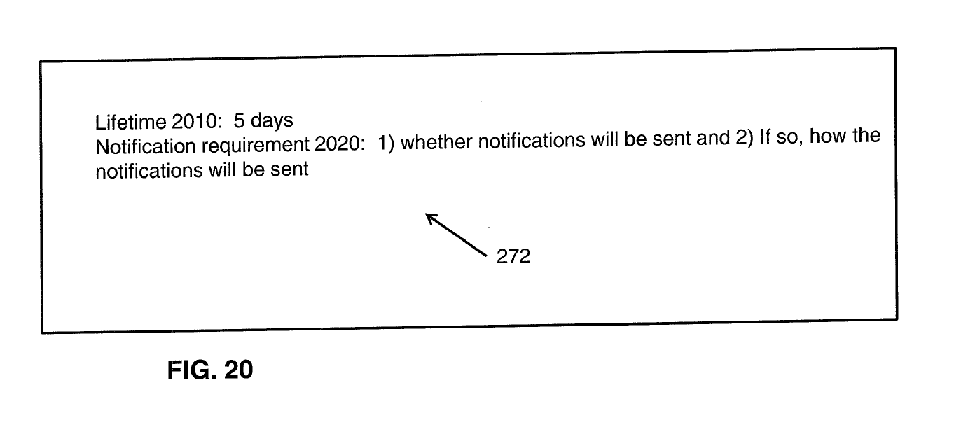

It remains to discuss how licensing and billing can be effected when a handheld device contains a sign cache. This cache serves to improve bandwidth utilization and response time through proactive virtual sign fetching, but since there is no message to the sign server caused by the user of the handheld device viewing a sign, there is no basis for usage-based charging. Similarly, the virtual sign may persist in the sign cache beyond the time that a licensing authority has authorized the display of the sign. Accordingly, virtual signs may be extended by additional information when fetched from the sign server. This information (e.g., as part of information 272 of a virtual sign 270; see FIG. 2 and FIG. 20) controls how long the virtual sign can reside in the sign cache, and what kinds of notifications are to be sent to the sign server when a sign is viewed.

Virtual signs can be augmented with a lifetime, representing the time left before the sign is potentially no longer visible. For example, if a sign is due to be re-authorized on March 31, and the virtual sign is fetched into the sign cache on March 27, the sign lifetime 2010 would be five days. When this time expires, the handheld device would automatically purge the virtual sign from the sign cache. This purging may include periodically inspecting all virtual signs for lifetime expiration and purging those whose lifetimes have expired. To support usage-based charging, a virtual sign can be augmented with a notification requirement 2020 specifying whether and how notifications will be sent to the sign server when a representation of the sign is viewed (or otherwise presented to a user). These notifications can cause the data records to be created or updated, as previously discussed, so that at the end of some period the data records can be supplied to the charging authority to aid in bill preparation. The notification can be simply that a given sign has been viewed, or how long it was viewed, or when it was viewed, or any combination.

It may be the case that a given handheld device has been disconnected from any communication with the sign server for some period of time. This might occur, for example, if its owner traveled to some place where radio connectivity is not available or where the connectivity is provided by a provider with whom the owner has no subscription, or if the owner is ill and has not turned on their device for some extended period of time. If pending notifications exist in the device for sign visibility events those notifications may not be sent in a manner permitting the accurate determination of a bill. In this case the agreement between the sign owner and the charging authority should specify some disposition of the charges implied by the (disconnected) user. For example, the charging authority might not charge for sign views from the disconnected user. However, when the user does connect, and the pending notifications are transmitted to the sign server, a retrospective bill (e.g., incremental charge) can be prepared. Alternatively, the sign viewing behavior of a disconnected user could be estimated using a model of past behavior and charging based on that estimation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus, comprising:
one or more memories comprising computer readable program code;
one or more processors configured in response to execution of the computer program code to cause the apparatus to perform at least the following:
determining a potential future location and a potential future heading of the apparatus;
requesting from a server a virtual sign that corresponds to the potential future location and potential future heading;
receiving from the server the virtual sign that corresponds to the potential future location and potential future heading and placing the virtual sign into a selected one of the one or more memories;
in response to a current location meeting the future location and a current heading meeting the future heading, presenting a representation of the virtual sign to the user; and
in response to the future location and future heading being determined as improbable, removing the virtual sign from the selected memory.

2. The apparatus of claim 1, wherein:
the apparatus further comprises one or both of a display or an audio output; and
presenting a representation of the virtual sign to the user further comprises presenting the representation using one or both of the display or the audio output.

3. The apparatus of claim 1, wherein determining a potential future location and a potential future heading of the apparatus further comprises determining the potential future location and potential future heading based on a previous location and previous heading.

4. The apparatus of claim 3, wherein the previous location and previous heading are on a path taken by the apparatus over a predetermined time period.

5. The apparatus of claim 1, wherein determining a potential future location and a potential future heading of the apparatus further comprises using at least map information, determining permissible movements of the apparatus relative to a surrounding area and using the permissible movements to determine the potential future location and the potential future heading.

6. The apparatus of claim 1, wherein determining a potential future location and a potential future heading of the apparatus further comprises determining the potential future location and the potential future heading by using knowledge of a planned r

7. An apparatus, comprising:
one or more memories comprising computer readable program code;
one or more processors configured in response to execution of the computer program code to cause the apparatus to perform at least the following:
accessing a timeline for a virtual sign;
determining an event from the timeline to be registered based on time and date information for the event being sooner in time and date than time and date information for any other events in the timeline;
registering the event;
determining that the registered event occurs in response to a current time and date meeting the time and date information for the registered event;
in response to the determining the registered event occurs, applying one or more changes to the virtual sign based on the event.

8. The apparatus of claim 7, wherein:
the virtual sign comprises first data;
the registered event comprises second data for the virtual sign; and
applying one or more changes further comprises modifying the first data with the second data.

9. The apparatus of claim 8, wherein:
the first data corresponds at least to how the virtual sign would be presented to a user via a first representation of the virtual sign; and
modifying the first data with the second data at least modifies the first representation of the virtual sign into a second representation of the virtual sign.

10. The apparatus of claim 9, wherein the registered event further comprises a command to modify the virtual sign with the second data.

11. The apparatus of claim 7, wherein:
the virtual sign is a selected virtual sign;
applying one or more changes to the virtual sign based on the registered event comprises making a state of the selected virtual sign be at least one predetermined state; and
the one or more processors are further configured in response to execution of the computer program code to cause the apparatus to perform at least the following:
in response to the state of the selected virtual sign being the at least one predetermined state, responding to requests for virtual signs with the selected virtual sign.

12. The apparatus of claim 11, wherein the at least one predetermined state comprises a visible state.

13. The apparatus of claim 11, wherein the at least one predetermined state comprises both an active and a visible state.

14. The apparatus of claim 7, wherein:
the virtual sign is a selected virtual sign;
applying one or more changes to the virtual sign based on the registered event comprises making a state of the selected virtual sign be at least one predetermined state; and
the one or more processors are further configured in response to execution of the computer program code to cause the apparatus to perform at least the following:
in response to the state of the selected virtual sign being the at least one predetermined state, responding to requests for virtual signs with virtual signs other than the selected virtual sign.

15. The apparatus of claim 14, wherein the at least one predetermined state comprises an invisible state.

16. The apparatus of claim 14, wherein:
the virtual sign is a first virtual sign;
the registered event comprises a command to modify a timeline of a second virtual sign; and
the one or more processors are further configured in response to execution of the computer program code to cause the apparatus to perform at least the following:
modifying the timeline of the second virtual sign based on the command.

17. The apparatus of claim 7, wherein:
the registered event is an event to make the virtual sign invisible based on the time and date information for the registered event;
the one or more processors are further configured in response to execution of the computer program code to cause the apparatus to perform at least the following, prior to registering the event:
determining a locality has not approved the virtual sign; and
in response to the determining the locality has not approved the virtual sign, adding the event to the timeline for the virtual sign.

18. The apparatus of claim 7, wherein:
the registered event is an event to make the virtual sign invisible based on the time and date information for the registered event;
the one or more processors are further configured in response to execution of the computer program code to cause the apparatus to perform at least the following, prior to registering the event:
determining a locality has not received license fees for the virtual sign; and
in response to the determining the locality has not approved the virtual sign, adding the event to the timeline for the virtual sign.

19. The apparatus of claim 7, wherein:
the virtual sign has a life cycle comprising the events of creation, one or more life events, and a disposal event; and
the registered event corresponds to one of the events of the life cycle.

20. The apparatus of claim 19, wherein the registered event is an event of dissipation, wherein applying one or more changes further comprising applying changes to a visual representation of the virtual sign in order to make the visual representation dissipate from an initial opacity to a clear opacity over a predetermined time period, and at the end of the predetermined time period the virtual sign is disposed of.

21. The apparatus of claim 20, further comprising inserting, in response to receiving a predetermined remuneration, a second event to cause the visual representation of the virtual sign to be presented again at the initial opacity.

22. The apparatus of claim 7, wherein:
the virtual sign corresponds to a virtual sign of a business;
the method further comprises, in response to receiving an indication that a remuneration of a competitor to the business is higher than the remuneration of the business, inserting an event in the timeline that causes the virtual sign of the business to be supplanted by the virtual sign of the competitor; and
determining an event to be registered determines the event to be registered is the event that causes the virtual sign of the business to be supplanted by the virtual sign.

23. The apparatus of claim 7, wherein:
the virtual sign corresponds to a virtual sign containing product placement;
the method further comprises, in response to receiving an indication that a remuneration for an advertiser is higher than remunerations from other advertisers, inserting an event in the timeline that causes the virtual sign modified by data placing brand information in predetermine places in the product placement; and
wherein determining an event to be registered determines the event to be registered is the event that causes the virtual sign modified by data placing brand information in predetermine places in the product placement.

24. An apparatus, comprising:
one or more memories comprising computer readable program code;
one or more processors configured in response to execution of the computer program code to cause the apparatus to perform at least the following:
for a selected virtual sign used to respond to requests received from mobile devices for virtual signs by transmitting the virtual sign to the mobile devices making the requests, determining charging information to be used by a charging authority to charge an owner of the virtual sign; and
sending the charging information to the owner of the virtual sign.

25. The apparatus of claim 24, wherein:
determining charging information further comprises determining a number of times the virtual sign was provided to the mobile devices requesting virtual signs; and
sending further comprises sending an indication of the number of times to the owner of the virtual sign.

26. The apparatus of claim 25, wherein determining a number of times the virtual sign was provided to the mobile devices requesting virtual signs further comprises:
inserting an event into a timeline for the virtual sign, the event comprising a command to cause access and reset of a database record recording the number of times the virtual sign was provided to mobile devices requesting virtual signs, the event corresponding to first time information and first date information;
recording in the database record the number of times the virtual sign was provided to mobile devices requesting virtual signs; and
in response to the event occurring based at least on the first time information and the second time information, accessing the database record and performing the sending the indication of the number of times to the owner of the virtual sign, resetting the database record, and inserting another event into a timeline for the virtual sign, the other event comprising the command to cause access and reset of the database record and corresponding to second time information and second date information, at least the second date information being different from and later than the first date information.

27. The apparatus of claim 24, wherein:
determining charging information further comprises receiving from the mobile devices indications of total time periods a representation of the virtual sign was presented by the mobile devices to users of the mobile devices; and
sending further comprises sending at least one indication of the total time periods to the owner of the virtual sign.
